(19) United States
(12) Patent Application Publication
(10) Pub. No.: US 2024/0414615 A1
(43) Pub. Date: Dec. 12, 2024

(54) SYSTEM AND METHOD FOR DYNAMIC RADIO RESOURCE SWITCHING

(71) Applicant: T-Mobile Innovations LLC, Overland Park, KS (US)

(72) Inventor: Timur KOCHIEV, Irvine, CA (US)

(21) Appl. No.: 18/331,356

(22) Filed: Jun. 8, 2023

(51) Int. Cl. H04W 36/14; H04B 17/318; H04W 36/30

(52) U.S. Cl. CPC H04W 36/1446; H04B 17/318; H04W 36/302; H04W 88/06

(57) ABSTRACT

Systems, methods, and devices for managing network resources perform and/or comprise: setting a communication threshold; monitoring a communication parameter for a wireless device connected to a network, wherein the wireless device is configured for communicating with the network using a first communication technology and for communicating with the network using a second communication technology; receiving a resource status from the network; and in response to a determination that the communication parameter is below the communication threshold and based on the resource status, causing the wireless device to switch from communicating with the network using the first communication technology to communicating with the network using the second communication technology.

### TECHNICAL BACKGROUND

Wireless telecommunications are generally provided via a plurality of geographically overlapping networks. From an infrastructure standpoint, a wireless device (“user equipment” or UE) may receive telecommunications services via an access node. For cellular telephone and data services, the individual networks may implement a plurality of radio access technologies (RATs) simultaneously using one or a plurality of access nodes. RATs can include, for example, 3G RATs such as Global System for Mobile Communications (GSM), Universal Mobile Telecommunications System (UMTS), Code-Division Multiple Access (CDMA), etc.; 4G RATs such as Worldwide Interoperability for Microwave Access (WiMAX), Long Term Evolution (LTE), etc.; 5G RATs such as new radio (NR), or newer RATs such as 6G.

Wireless devices may be connected to the access node either directly or indirectly. As an example of a direct connection, a wireless device may communicate with the access node via an Enhanced Mobile Broadband (eMBB) protocol, which provides for 5G communication between the wireless device and the access node. As an example of an indirect connection, a wireless device may communicate with a device such as a home router via a Fixed Wireless Access (FWA) Home Internet (HINT) protocol. In such a scenario, the home router communicates with the wireless device via one RAT such as Wi-Fi and communicates with the access node via another RAT such as 5G NR, thus acting as an intermediary to provide indirect communication between the wireless device and the access node. A network operator may implement radio-resource partitioning to allocate a certain proportion of radio resources to FWA users and the remaining radio resources to eMBB users.

### Overview

Various aspects of the present disclosure relate to systems and methods of managing network communications (e.g., by dynamically switching radio resource usage) in a telecommunications network.

In one exemplary aspect of the present disclosure, a method of managing network resources comprises setting a communication threshold; monitoring a communication parameter for a wireless device connected to a network, wherein the wireless device is configured for communicating with the network using a first communication technology and for communicating with the network using a second communication technology; receiving a resource status from the network; and, in response to a determination that the communication parameter is below the communication threshold and based on the resource status, causing the wireless device to switch from communicating with the network using the first communication technology to communicating with the network using the second communication technology.

In another exemplary aspect of the present disclosure, a system for managing network resources comprises a local router; an access node; and a wireless device capable of communicating with a network via the local router using a first communication technology and via the access node using a second communication technology, the wireless device including at least one electronic processor configured to perform operations including: monitoring a communication parameter for communications between the wireless device and the local router using the first communication technology, monitoring a resource availability for the access node, and based on the communication parameter and the resource availability, switching from communicating with the network via the local router using the first communication technology to communicating with the network via the access node using the second communication technology.

In yet another exemplary aspect of the present disclosure, a wireless device comprises first communication circuitry configured to communicate with an access node indirectly via a local router using a first communication technology; second communication circuitry configured to communicate with the access node directly using a second communication technology; and at least one electronic processor configured to, in response to a determination that the wireless device is near an edge of a coverage area of the local router and a determination that an amount of available resources of the access node exceeds a threshold, cause the wireless device to switch from communicating with the access node indirectly using the first communication circuitry to communicating with the access node directly using the second communication technology.

In this manner, these and other aspects of the present disclosure provide for improvements in at least the technical field of telecommunications, as well as the related technical fields of network management, device management, network security, wireless communications, and the like.

This disclosure can be embodied in various forms, including hardware or circuits controlled by computer-implemented methods, computer program products, computer systems and networks, user interfaces, and application programming interfaces; as well as hardware-implemented methods, application specific integrated circuits, field programmable gate arrays, and the like. The foregoing summary is intended solely to provide a general idea of various aspects of the present disclosure, and does not limit the scope of the disclosure in any way.

### BRIEF DESCRIPTION OF THE DRAWINGS

These and other more detailed and specific features of various embodiments are more fully disclosed in the following description, reference being had to the accompanying drawings, in which:

FIG. 1 illustrates an exemplary system for wireless communication in accordance with various aspects of the present disclosure;

FIG. 2 illustrates an exemplary configuration of a system for wireless communication in accordance with various aspects of the present disclosure

FIG. 3 illustrates an exemplary access node in accordance with various aspects of the present disclosure;

FIG. 4 illustrates an exemplary router in accordance with various aspects of the present disclosure;

FIG. 5 illustrates an exemplary wireless device in accordance with various aspects of the present disclosure; and

FIG. 6 illustrates an exemplary process flow for managing resources in accordance with various aspects of the present disclosure.

### DETAILED DESCRIPTION

In the following description, numerous details are set forth, such as flowcharts, schematics, and system configurations. It will be readily apparent to one skilled in the art that these specific details are merely exemplary and not intended to limit the scope of this application.

In addition to the particular systems and methods described herein, the operations described herein may be implemented as computer-readable instructions or methods, and a processing node or nodes on the network for executing the instructions or methods. The processing node or nodes may include an electronic processor included in the access node and/or an electronic processor included in any controller node in the wireless network that is coupled to the access node.

As noted above, certain wireless devices may be configured to communicate using several different RATs. For example, a smartphone may be configured to communicate both using a cellular connection via a 3^{rd} Generation Partnership Project (3GPP) RAT such as NR and using a local connection to a HINT router (which may itself be connected to the network via NR) via a technology such as Wi-Fi. Network providers sometimes partition the radio resources such that a certain proportion are allocated solely to the connections with wireless devices such as smartphones themselves, while the remaining proportion are able to be used for the with the devices which provide local connections (e.g., 30% of available resources dedicated for FWA, with the remaining 70% of available resources used by eMBB users). When a wireless device is near a base station (such as an HINT router), it will typically access the network using the “local” RAT (e.g., Wi-Fi from the HINT router) and thus not occupy the dedicated resources. However, because local RATs such as Wi-Fi generally operate over a smaller coverage area compared to RATs such as NR, communications using the local RATs may degrade if the user strays too far from the base station providing access via the local RATs. At an edge of a coverage area of the local RAT, in fact, a user may experience poorer performance on the local RAT compared to the wider RAT even if the user is still able to connect to the base station. Accordingly, the present disclosure provides for systems, methods, applications, and devices to switch a wireless device with traffic demand to available 3GPP resources dynamically based on communication conditions and/or periodicity.

The term “wireless device” refers to any wireless device included in a wireless network. For example, the term “wireless device” may include a relay node, which may communicate with an access node. The term “wireless device” may also include an end-user wireless device, which may communicate with the access node through the relay node. The term “wireless device” may further include a UE or end-user wireless device that communicates with the access node directly without being relayed by a relay node. Additionally, “wireless device” may encompass any type of wireless device, such as a smartphone, a tablet, a laptop computer, a desktop computer with wireless communication capabilities, and so on. The term “wireless device” is used interchangeably with the term “wireless communication device” herein.

In accordance with various aspects of the present disclosure, a cellular or wireless network may be provided by an access node. While examples described herein may include at least an access node (or base station), such as an Evolved Node B (eNodeB) or a next-generation Node B (gNodeB), and one or a plurality of end-user wireless devices; however, the present disclosure is not limited to such a configuration. Various aspects of the present disclosure may also be applied to communication between an end-user wireless device and other network resources, such as relay nodes, controller nodes, antennas, and so on. Moreover, multiple access nodes may be utilized. For example, some wireless devices in the network may communicate with an LTE eNodeB, while others may communicate with an NR gNodeB, while still others may communicate with a Non-Terrestrial Network (NTN) satellite. Additionally, for purposes of illustration and explanation, various portions of this detailed description refer to implementations in a network a 5G NR RAT; however, the present disclosure is not so limited. The systems and methods described herein may be implemented in a network using any RAT, including further extensions or updated implementations of 5G (e.g., 5G Advanced) or newer generations of RATs such as 6G.

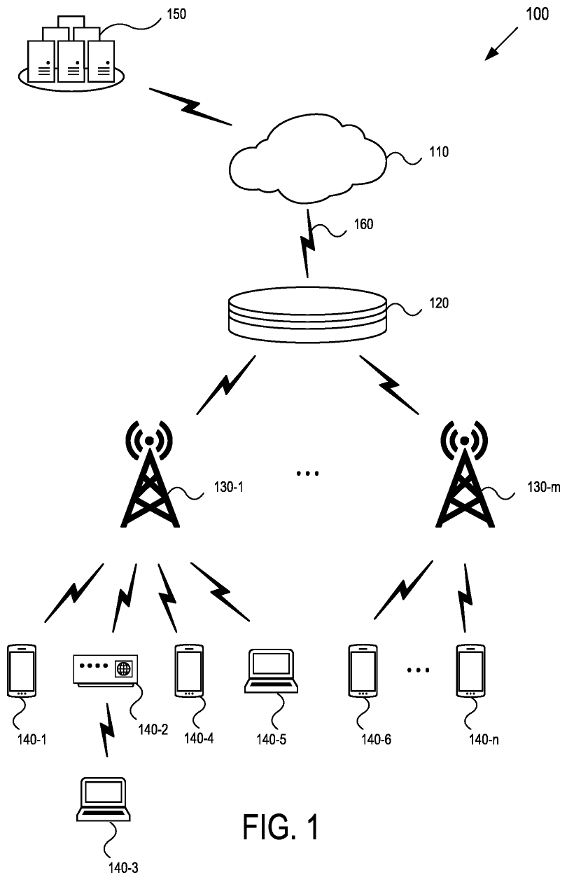

FIG. 1 illustrates an exemplary system 100 for use with various aspects of the present disclosure. In practical implementations the system 100 may correspond to any RAT or combinations of RATs, including but not limited to 3G RATs such as GSM, UMTS, CDMA, etc.; 4G RATs such as WiMAX, LTE, etc.; 5G RATs such as NR; NTN RATs; and further extensions or updated implementations of the same. As illustrated, the system 100 includes a cloud platform 110, a core network 120, and a plurality of access nodes 130-1 to 130-m (collectively referred to as access nodes 130), and a plurality of wireless devices 140-1 to 140-n (collectively referred to as wireless devices 140). Other computing systems and devices 150 may be connected to the cloud platform 110, for example to monitor and/or control the wireless devices 140. While FIG. 1 illustrates only two of the access nodes 130, in practical implementations any number of the access nodes 130 (including one) may be present in the system 100. Moreover, while FIG. 1 illustrates seven of the wireless devices 140 and illustrates various subsets of the wireless devices 140 being connected to individual ones of the access nodes 130, the present disclosure is not so limited. In practical implementations, any number of the wireless devices 140 (including zero or one) may be present in total, and any number of such wireless devices 140 (including zero or one) may be connected to each access node 130. As illustrated, various elements of FIG. 1 are connected to one another via wireless connections; however, some of the connections may be wired connections. For example, an access node 130 may be connected to the core network 120 via a wired connection.

The cloud platform 110, which may be an LTE cloud platform, an NR cloud platform, an NTN cloud platform, or a combination thereof may perform processing and forward results to the computing systems and devices 150 and/or the wireless devices 140. The core network 120, which may be an LTE core network, a 5G Core Network (5GCN), an NTN, or combinations thereof, connects with the cloud platform 110 and the access nodes 130. Subsets of the access nodes 130 may be respectively configured to provide service in different areas, on different bands, for different RATs, and so on. FIG. 1 illustrates a situation in which the system 100 is operated by a single network operator. In many geographical areas, multiple access nodes 130 provide coverage that may overlap.

The access nodes 130 communicate with the core network 120 via one or more communication links, each of which may be a direct link (e.g., an N2 link, an N3 link, or the like), a wireless link (e.g., a satellite link), or combinations thereof. The access nodes 130 may further communicate with one another and/or with additional access nodes via a direct link, a wireless link, or combinations thereof. A scheduling entity may be located within the access nodes 130 and/or the core network 120, and may be configured to accept, deny, and route connection requests and manage communication sessions, for example to enforce a selected network topology. The access nodes 130 may be any network node configured to provide communications between the connected wireless devices 140 and the core network 120 and cloud platform 110, including standard access nodes; short range, lower power, small access nodes; or long range non-terrestrial access nodes. As examples of a standard access node, the access nodes 130 may be a macrocell access node, a base transceiver station, a radio base station, a gNodeB in 5G networks, an eNodeB in 4G/LTE networks, or the like, including combinations thereof. In one particular example, the access nodes 130 may be a macrocell access node in which a range of its coverage area is from approximately five to thirty-five kilometers (km) and in which the output power is in the tens of watts (W). As examples of a small access node, the access nodes 130 may be a microcell access node, a picocell access node, a femtocell access node, or the like, including a home gNodeB or a home eNodeB. As examples of a non-terrestrial access node, the access nodes 130 may be a geosynchronous equatorial orbit (GE) satellite, a medium earth orbit (MEO satellite, a low earth orbit (LEO) satellite, or the like.

An access node 130 may comprise one or more electronic processors and associated circuitry to execute or direct the execution of computer-readable instructions such as those described herein. In so doing. the access node 130 can retrieve and execute software from storage, which can include a disk drive, a flash drive, memory circuitry, or some other memory device, and which may be local or remotely accessible. The software may comprise computer programs, firmware, or some other form of machine-readable instructions, and may include an operating system, utilities, drivers, network interfaces, applications, or some other type of software, including combinations thereof. Moreover, the access node 130 can receive instructions and other input at a user interface.

The wireless devices 140 are devices configured with appropriate technologies for connecting to the cloud platform 110. The wireless devices 140 may be or include mobile communication devices such as smartphones, laptop computers, tablet computers, desktop computers with wireless communication capabilities, and the like; vehicles such as cars, trucks, and the like; connectivity devices such as modems, routers, and the like, and/or Internet-of-Things (IoT) devices such as smart-home sensors or industrial sensors, and the like. A wireless device 140 may include one or more electronic processors and associated circuitry to execute or direct the execution of computer-readable instructions such as those described herein. The wireless device 140 may further include a memory, wireless communication circuitry, and other components. While the present disclosure is presented mainly with regard to 3GPP wireless devices communicating over a radio access network (RAN), in practical implementations one or more of the access nodes 130 and/or wireless devices 140 may be configured to include other types of access mechanisms.

In general, the network provided by the system 100 can be a wired and/or wireless communication network, and can comprise processing nodes, routers, gateways, and physical and/or wireless data links for carrying data among various network elements, including combinations thereof, and can include a local area network (LAN) or a wide area network (WAN), and an internetwork (including the Internet). The network can be capable of carrying data, for example to support voice, push-to-talk (PTT), broadcast video, and/or data communications by the wireless devices 140. Wireless network protocols can comprise Multimedia Broadcast Multicast Services (MBMS), CDMA, 1×RTT, GSM, UMTS, High Speed Packet Access (HSPA), Evolution-Data Optimised (EV-DO), EV-DO rev. A. 3GPP LTE, WiMAX, 4G including LTE Advanced and the like, 5G including 5G NR or 5G Advanced, or combinations thereof, and 6G. Wired network protocols that may be utilized by the network comprise Ethernet, Fast Ethernet, Gigabit Ethernet, Local Talk (e.g., Carrier Sense Multiple Access with Collision Avoidance), Token Ring, Fiber Distributed Data Interface (FDDI), and Asynchronous Transfer Mode (ATM). The network may also comprise additional base stations, controller nodes, telephony switches, internet routers, network gateways, computer systems, communication links, other types of communication equipment, and combinations thereof.

The communication links 160 connecting various components of the system 100 may respectively use various communication media, such as air, space, metal, optical fiber, other signal propagation paths, and combinations thereof. The communication links may respectively be wired or wireless and use various communication protocols such as Internet, Internet protocol (IP), LAN, optical networking, hybrid fiber coax (HFC), telephony, T1, other communication formats, and combinations, improvements, or variations thereof. Wireless communication links may use electromagnetic waves in the radio frequency (RF), microwave, infrared (IR), or other wavelength ranges, and may use a suitable communication protocol, including but not limited to MBMS, CDMA, 1×RTT, GSM, UMTS, HSPA, EV-DO, EV-DO rev. A, 3GPP LTE, WiMAX, 4G including LTE Advanced and the like, and 5G including 5G NR or 5G Advanced, NTN, 6G, or combinations thereof. The communication links may respectively be a direct link or might include various equipment, intermediate components, systems, and networks. The communication links may comprise many different signals sharing the same link.

In a 5G implementation, the cloud platform 110, the core network 120, and/or the access nodes 130 may collectively implement several control plane network functions (NFs) and user plane NFs. The control plane NFs include but are not limited to a Network Slice Selection Function (NSSF), a Network Exposure Function (NEF), a NF Repository Function (NRF), a Policy Control Function (PCF), a Unified Data Management (UDM), an Application Function (AF), a Short Message Service Function (SMSF), a Core Access and Mobility management Function (AMF), a Session Management Function (SMF), and an Authentication Server Function (AUSF). The user plane NFs include but are not limited to a User Plane Function (UPF). Control plane NFs can provide one or more NFs based on a request-response or subscribe-notify model. The NFs may form a micro services-based architecture, which may include network functions distributed over different cloud infrastructures. Additionally, many services may span different network functions and domains that work in unison.

The NRF maintains the list of available network functions and their profiles. The NRF maintains an updated repository of the network components along with services provided by each of the elements in the core network. The NRF additionally provides a discovery mechanism that allows the elements to discover each other. The NRF provides a registration function that allows each network function to register a profile and a list of services with the NRF. It also performs services registration and discovery so that different network functions can find each other. As one example, the SMF, which is registered to NRF, becomes discoverable by the AMF when a UE or other device tries to access a service type served by the SMF. The NRF broadcasts available services once they are registered in the core network 120. To use other network functions, registered functions can send service requests to the NRF.

The UDM interfaces with NEs such as AMF and SMF so that relevant data becomes available to AMF and SMF. The UDM generates authentication vectors when requested by the AUSF, which acts as an authentication server. The AMF performs the role of access point to the core network 120, thereby terminating RAN control plane and UE traffic originating on either the N1 or N2 reference interface. In the core network 120, the functionality of the 4G Mobility Management Entity (MME) is decomposed into the AMF and the SMF. The AMF receives all connection and session related information from the UE using N1 and N2 interfaces, and is responsible for handling connection and mobility management tasks.

A Unified Data Repository (UDR) may also be present. The UDR may provide unified data storage accessible to both control plane NFs and user plane NFs. Thus, the UDR may be a repository shared between control plane NFs and the UPF. The UDR may include information about subscribers, application-specific data, and policy data. The UDR can store structured data that can be exposed to an NF. The UPF may perform operations including, but not limited to, packet routing and forwarding, packet inspection, policy enforcement for the user plane, Quality-of-Service (QoS) handling, etc. When compared with 4G EPC, the functions of the UPF may resemble those of the SGW-U (Serving Gateway User Plane function) and PGW-U (PDN Gateway User Plane function).

In an NTN implementation, there may be a RAN serving multiple UEs by a radio frequency transmission provided by utilizing orbiting satellites that may be in communication with access nodes (e.g., some of the access nodes 130) of a terrestrial network (TN). The NTN includes NTN nodes that are not stationed on the ground as a complement to the TNs. The NTN may be one of three types of satellite-based NG-RAN architectures: transparent satellite-based NG-RAN, regenerative satellite-based NG-RAN, and multi-connectivity involving satellite-based NG-RAN. Transparent satellite-based NG-RAN implements frequency conversion and a radio frequency amplifier in both uplink and downlink directions. Several transparent satellites may be connected to the same gNB on the ground through New Radio Uplink Unicast (NR-Uu). Regenerative satellite-based NG-RAN implements regeneration of the signals received from earth. The satellite payload also provides Inter-station Signaling Links (ISL) between satellites. An ISL may be a radio interface or an optical interface that may be 3GPP or non-3 GPP defined. The regenerative satellite-based NGRAN architecture may be gNB processed payload (has both gNB Centralized Unit (gNB-CU) and gNB Distributed Unit (gNB-DU)) processed payload. Multi-connectivity involving satellite-based NG-RAN applies to transparent satellites as well as regenerative satellites with gNB or gNB-DU function on board.

Other network elements may be present in the system 100 to facilitate communication but are omitted for clarity, such as base stations, base station controllers, mobile switching centers, dispatch application processors, and location registers such as a home location register or visitor location register. Furthermore, other network elements that are omitted for clarity may be present to facilitate communication, such as additional processing nodes, routers, gateways, and physical and/or wireless data links for carrying data among the various network elements, e.g., between the access node 130 and the core network 120.

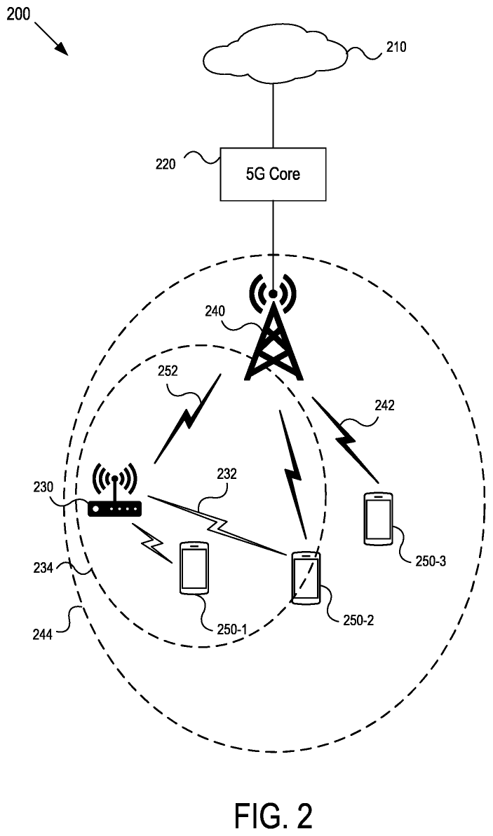

FIG. 2 illustrates a configuration in which a system 200 provides overlapping network coverage via an access node and a local router within a particular area. For purposes of illustration and explanation, the system 200 is illustrated as a 5G System (5GS); however, in practical implementations the system 200 may correspond to any RAT or combinations of RATs, including but not limited to 3G RATs such as GSM, UMTS, CDMA, etc.; 4G RATs such as WiMAX, LTE, etc.; 5G RATs such as NR; 6G RATs; and further extensions or updated implementations of the same.

As illustrated, the system 200 comprises a communication network 210, a 5G core 220, an local router 230 which provides service in a first coverage area 234, an access node 240 which provides service in a second coverage area 244, and a plurality wireless devices 250-1 to 250-3 (collectively referred to as wireless devices 250). The wireless devices 250 may be connected to the local router 230 via first communication links 232 and/or may be connected to the access node 240 via second communication links 242. The local router 230 is connected to the access node 240 via a third communication link 252. Thus, a wireless device 250 is said to be “indirectly” connected to the access node 250 if it connects via a first communication link 232 and the third communication link 252 (i.e., via the local router 230) and “directly” connected to the access node 240 if it connects via a second communication link 242. For purposes of illustration and ease of explanation, only one local router 230, one access node 240, and three wireless devices 250 are shown in the system 200; however, as noted above with regard to FIG. 1, additional access nodes and/or additional or fewer wireless devices may be present in the system 200. In the illustration of FIG. 2, the access node 240 is connected to the communication network 210 via an NR path (including the 5G core 220); however, in practical implementations the access node 240 may be connected to the communication network 210 via multiple paths (e.g., using multiple RATs). The access node 240 communicates with the 5G core 220 via one or more communication links, each of which may be a direct link (e.g., an N2 link, an N3 link, or the like). The access node 240 may also communicate with additional access nodes via a direct link.

The local router 230 is located within the second coverage area 244, and thus may access network services via the third communication link 252 with the access node 240. The local router 230 then provides network services to wireless devices 250 located within the first coverage area 234, such as the wireless device 250-1. The access node 240 also provides network services to wireless devices 250 located within the second coverage area 244 and not already receiving said network services from the local router 230, such as the wireless device 250-3. As illustrated, the wireless device 250-2 is near an edge of the first coverage area 234. Depending on the communication quality of the connection between the wireless device 250-2 and the local router 230 relative to the communication quality of the connection between the wireless device 250-2 and the access node 240, and by implementing the systems and methods described herein, the wireless device 250-2 may switch or be switched between communicating with the local router 230 via the first communication link 232 using the first communication technology and communicating with the access node 240 via the second communication link 242 using the second communication technology.

As illustrated, the local router 230 is connected to the same access node 240 to which the wireless devices 250 may connect; however, the present disclosure is not so limited. In practical implementations, the local router 230 may instead be connected to another access node (not shown in FIG. 2). Moreover, while FIG. 2 illustrates the first coverage area 234 as being fully subsumed within the second coverage area 244, in practical implementations the first coverage area 234 may extend to locations outside of the second coverage area 244, for example to locations which are within the coverage area of another access node.

The communication network 210 can be a wired and/or wireless communication network, and can comprise processing nodes, routers, gateways, and physical and/or wireless data links for carrying data among various network elements, including combinations thereof, and can include a LAN or a WAN, and an internetwork (including the Internet). The communication network 210 can be capable of carrying data, for example to support voice, push-to-talk (PTT), broadcast video, and/or data communications by the wireless devices 250. Wireless network protocols can comprise MBMS, CDMA, 1×RTT, GSM, UMTS, HSPA, EV-DO, EV-DO rev. A. 3GPP LTE, WiMAX, 4G including LTE Advanced and the like, 5G including 5G NR or 5G Advanced, 6G or combinations thereof. Wired network protocols that may be utilized by the communication network 210 comprise Ethernet, Fast Ethernet, Gigabit Ethernet, Local Talk (e.g., Carrier Sense Multiple Access with Collision Avoidance), Token Ring, FDDI, and ATM. The communication network 210 may also comprise additional base stations, controller nodes, telephony switches, internet routers, network gateways, computer systems, communication links, other types of communication equipment, and combinations thereof.

The communication links connecting the access node 240 to the 5G core 220 may respectively use various communication media, such as air, space, metal, optical fiber, other signal propagation paths, and combinations thereof. The communication links may respectively be wired or wireless and use various communication protocols such as Internet, IP, LAN, optical networking, HFC, telephony, T1, other communication formats, and combinations, improvements, or variations thereof. Wireless communication links may use electromagnetic waves in the RF, microwave, IR, or other wavelength ranges, and may use a suitable communication protocol, including but not limited to MBMS, CDMA, 1×RTT, GSM, UMTS, HSPA, EV-DO, EV-DO rev. A. 3GPP LTE, WiMAX, 4G including LTE Advanced and the like, 5G including 5G NR or 5G Advanced, 6G or combinations thereof as noted above. The communication links may respectively be a direct link or might include various equipment, intermediate components, systems, and networks. The communication links may comprise many different signals sharing the same link. The communication network 210, the access node 240, and/or the 5G core 220 may collectively implement several control plane NFs and user plane NFs which are described above.

Other network elements may be present in the system 200 to facilitate communication but are omitted for clarity, such as base stations, base station controllers, mobile switching centers, dispatch application processors, and location registers such as a home location register or visitor location register. Furthermore, other network elements that are omitted for clarity may be present to facilitate communication, such as additional processing nodes, routers, gateways, and physical and/or wireless data links for carrying data among the various network elements, e.g., between the access node 240 and the communication network 210.

A scheduling entity may be located within the local router 230, the access node 240, and/or the 5G core 220, and may be configured to accept and deny connection requests and manage communication sessions, to allocate resources and RATs to improve overall network resource utilization and performance, to configure connected wireless devices, and the like. The local router 230 may be any network device configured to provide wireless communications within a comparatively small (compared to the access node 240) area, such as a LAN, a personal area network (PAN), a home area network (HAN), a corporate area network (CAN), a metropolitan area network (MAN), and so on. In one particular example, the local router 230 is a HINT router configured to provide communication services using a FWA technology. The access node 240 may be any network node configured to provide communications between the connected wireless devices 250 and the communication network 210, including standard access nodes and/or short range, lower power, small access nodes. As examples of a standard access node, the access node 240 may be a macrocell access node, a base transceiver station, a radio base station, a gNodeB in 5G networks, an eNodeB in 4G/LTE networks, or the like, including combinations thereof. In one particular example, the access node 240 may be a macrocell access node in which a range of the second coverage area 244 is from approximately five to thirty-five kilometers (km) and in which the output power is in the tens of watts (W). As examples of a small access node, the access node 240 may be a microcell access node, a picocell access node, a femtocell access node, or the like, including a home gNodeB or a home eNodeB.

The access node 240 can comprise one or more electronic processors and associated circuitry to execute or direct the execution of computer-readable instructions such as those described herein. In so doing, the access node 240 can retrieve and execute software from storage, which can include a disk drive, a flash drive, memory circuitry, or some other memory device, DONE and which may be local or remotely accessible. The software may comprise computer programs, firmware, or some other form of machine-readable instructions, and may include an operating system, utilities, drivers, network interfaces, applications, or some other type of software, including combinations thereof. Moreover, the access node 240 can receive instructions and other input at a user interface.

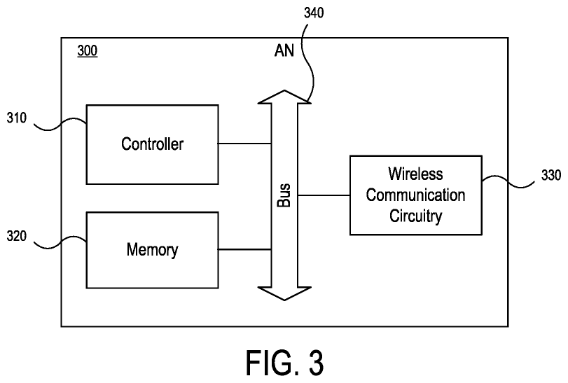

FIG. 3 illustrates one example of an access node 300, which may correspond to one or more of the access nodes 130 shown in FIG. 1 and/or the access node 240 shown in FIG. 2. The access node 300 may be configured to communicate with a plurality of wireless devices using a wideband (e.g., a carrier or combination of carriers). As illustrated, the access node 300 includes a controller 310, a memory 320, wireless communication circuitry 330, and a bus 340 through which the various elements of the access node 300 communicate with one another. The controller 310 is one example of an electronic processor, and may include sub-modules or units, each of which may be implemented via dedicated hardware (e.g., circuitry), software modules which are loaded from the memory 320 and processed by the controller 310, firmware, and the like, or combinations thereof. The various sub-modules or units may include or implement logic circuits, thereby to perform operations such as setting parameters, monitoring parameters, comparing parameters, generating instructions, and so on.

The wireless communication circuitry 330 may include circuit elements configured for inbound communication to receive wireless signals (e.g. one or more antennas) as well as interface elements configured, for example, to translate data signals from wireless input into control or other signals for the controller 310. Moreover, the wireless communication circuitry 330 may include circuit elements configured for outbound communication to generate wireless signals (e.g., one or more antennas) as well as interface elements configured, for example, to translate control signals from the controller 310 into data signals for wireless output. For example, the access node 300 may be configured to receive communications from the wireless device via the wireless communication circuitry 330 and output communications and/or control signals or instructions to the wireless device via the wireless communication circuitry 330, thereby managing traffic and network resources. In an example, the wireless communication circuitry 330 is configured to communicate with connected wireless devices using a 5G RAT and with connected local routers using a FWA RAT. The access node 300 may include additional wireless communication circuitry elements, for example to communicate using additional frequencies and/or to provide connectivity for different RATs. The access node 300 may further include additional wired communication circuitry elements.

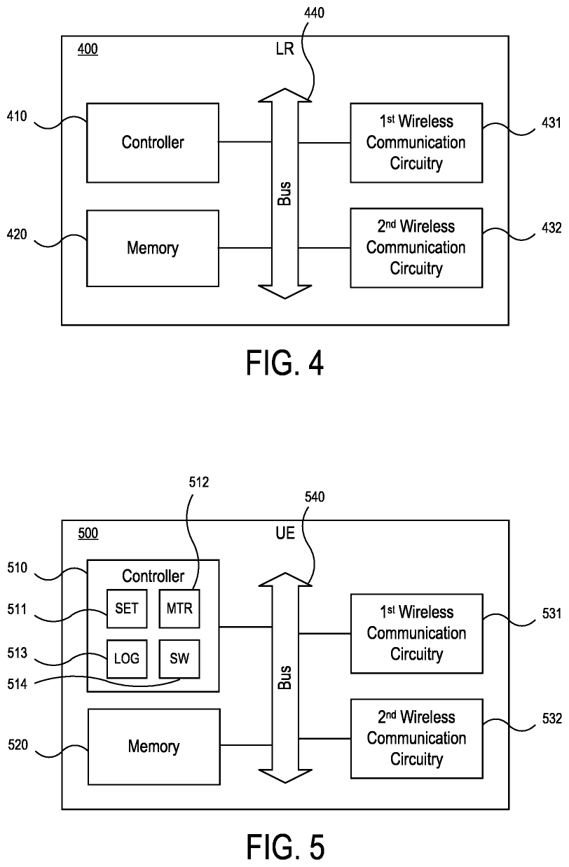

FIG. 4 illustrates one example of a local router 400, which may correspond to the wireless device 140-2 shown in FIG. 1 and/or the local router 230 shown in FIG. 2. The local router may be configured to communicate with an access node using a wideband for upstream communication and with one or more wireless devices using a local band for downstream communication. As illustrated, the local router 400 includes a controller 410, a memory 420, a first wireless communication circuitry 431, a second wireless communication circuitry 432, and a bus 440 through which the various elements of the local router 400 communicate with one another. The controller 410 is one example of an electronic processor, and may include sub-modules or units, each of which may be implemented via dedicated hardware (e.g., circuitry), software modules which are loaded from the memory 420 and processed by the controller 410, firmware, and the like, or combinations thereof. The various sub-modules or units may include or implement logic circuits, thereby to perform operations such as setting parameters, monitoring parameters, comparing parameters, generating instructions, and so on.

The first and second wireless communication circuitry 431, 432 may respectively include circuit elements configured for inbound communication to receive wireless signals (e.g. one or more antennas) as well as interface elements configured, for example, to translate data signals from wireless input into control or other signals for the controller 410. Moreover, the first and second wireless communication circuitry 431, 432 may respectively include circuit elements configured for outbound communication to generate wireless signals (e.g., one or more antennas) as well as interface elements configured, for example, to translate control signals from the controller 410 into data signals for wireless output. For example, the local router 400 may be configured to receive communications from a connected wireless device via the first wireless communication circuitry 431 and output communications and/or control signals or instructions to the wireless device via the first wireless communication circuitry 431, and to receive communications from an access node via the second wireless communication circuitry 432 and output communications and/or control signals or instructions to the access node via the second wireless communication circuitry 432. In an example, the first wireless communication circuitry 431 is configured to communicate with connected wireless devices using Wi-Fi and the second wireless communication circuitry 432 is configured to communicate with the access node using a FWA RAT. The local router 400 may include additional wireless communication circuitry elements, for example to communicate using additional frequencies and/or to provide connectivity for different RATs. The local router 400 may further include additional wired communication circuitry elements, for example to communicate with one or more local devices via Ethernet.

FIG. 5 illustrates one example of a wireless device 500 (i.e., a UE), which may correspond to one or more of the wireless devices 140 shown in FIG. 1 and/or one or more of the wireless devices 250 shown in FIG. 2. As illustrated, the wireless device 500 includes a controller 510, a memory 520, a first wireless communication circuitry 531, a second wireless communication circuitry 532, and a bus 540 through which the various elements of the wireless device 500 communicate with one another. The controller 510 includes various sub-modules or units to implement operations and processes in accordance with the present disclosure. For example, the controller 510 may include modules that (e.g., in response to commands or instructions from an access node, a local router, or the wireless device 500 itself) may cause the wireless device 500 to switch communication technologies. As illustrated, the controller 510 includes a setting module 511, a monitoring module 512, a logic module 513, and a switching module 514. Alternatively, the controller 510 may load a module from the memory 520 (e.g., a software module) to switch among various carriers and/or various BWPs.

Some or all of the sub-modules or units may physically reside within the controller 510. or may instead reside within the memory 520 and/or may be provided as separate units within the wireless device 500, in any combination. In one example, the modules may be implemented in the form of an executable application (an “app”). While FIG. 5 illustrates the setting module 511, the monitoring module 512, the logic module 513, and the switching module 514 as being separate modules, in practical implementations some of the modules may be combined with one another and/or may share components (e.g., logic gates). Through the setting module 511, the monitoring module 512, the logic module 513, and the switching module 514, the wireless device 500 (e.g., the controller 510) may be configured to perform various operations to implement methods in accordance with the present disclosure. While one example of operations performed by the modules is described here, in practical implementations at least some of the operations described as being performed by one module may instead be performed by another module, including a module not explicitly named here.

The wireless device may be configured for communicating with the network using a first communication technology (e.g., FWA using a combination of Wi-Fi and 5G NR) and for communicating with the network using a second communication technology (e.g., eMBB). The setting module 511 may be configured to set a communication threshold. The communication threshold may be a threshold signal level below which it may be determined that the communications using the RAT corresponding to the signal are undesirably poor. In one example, the communication threshold may correspond to communications in the first communication technology. The communication threshold may be set by a network operator. In some examples, multiple communication thresholds may be set.

The monitoring module 512 may be configured to monitor a communication parameter or, in some implementations, multiple communication parameters. The communication parameter may correspond to a signal strength for communications between the wireless device 500 and a local router (e.g., the local router 400). The communication parameter may be related to any measure of the quality or strength of wireless communications between the wireless device 500 and the local router using the first communication technology, including but not limited to a throughput, a signal level, an RF signal strength, a signal to noise ratio (SNR), a SINR, a reverse noise rise (RNR), a latency, a packet loss percentage, and the like. The value of the communication parameter may be determined as an average over a predetermined time window, the length of which may be set or reset by a network operator. In some implementations, the actual value of the communication parameter may be determined by the local router itself, and the monitoring module 512 may monitor information from the local router in determining the actual value of the communication parameter. The monitoring module 512 may also be configured to monitor or determine resource status of the network, such as by querying and/or receiving the resource status or information related thereto from the network (e.g., from the local router or from an access node). The resource status may correspond to an amount of available resources for communications using the second communication technology between the wireless device and the access node using the second communication technology, including but not limited to an amount of used or available resource blocks (RBs) or resource block groups (RBGs). The operations performed by the monitoring module 512 may be performed continuously or continually, such as at predetermined time intervals the length of which may be determined by a network operator. In determining the resource status, the monitoring module 512 may use or receive historical data over a predetermined period of time (e.g., a period set by the network operator), which in some implementations is stored in the memory 520. In some implementations, the resource status may be determined by a machine learning (ML) or artificial intelligence (AI) algorithm, for example based on a historical resource usage of an access node, and may be queried by the wireless device 500. In such implementations, the ML or AI algorithm may reside in the access node, in the wireless device 500, or in any other network entity. The ML or AI algorithm may be trained on one or more datasets including historical resource usage, traffic, latency, or other parameters related to a resource allocation of the network.

The logic module 513 may be configured with various logic circuits or elements in order to various logic operations, including but not limited to operations of comparing, monitoring, and identifying various aspects of the network and/or the wireless device 500. The logic module 513 may perform operations to determine whether the wireless device 500 is at or near an edge of a coverage area of the local router (e.g., at a periphery of the first coverage area 234 shown in FIG. 2). In an example of determining that the wireless device 500 is near the edge, the logic module 513 may be configured to compare the communication parameter with the communication threshold. The logic module 513 may be configured to output the result of the determination; for example, the logic module 513 may output a signal indicating whether the communication parameter is above or below the communication threshold. In some implementations, the logic module 513 may be configured to perform output based on the resource status; for example, by only outputting the signal indicating whether the communication parameter is above or below the communication threshold if the resource status indicates a certain amount of available resources for communication using the second communication technology. The logic module 513 may additionally or alternatively be configured to determine whether an expected communication quality (e.g., expected signal strength, expected throughput, expected latency, etc.) between the network and the wireless device is higher using the first communication technology or using the second communication technology.

The switching module 514 may be configured to determine the manner in which the wireless device 500 performs communications with the network. For example, the switching module 514 may be configured to, in response to a determination that the communication parameter is below the communication threshold (e.g., by the logic module 513) and based on the resource status, cause the wireless device 500 to switch from communicating with the network indirectly using the first communication technology (i.e., communicating with the local router which in turn communicates with the access node) to communicating with the network directly using the second communication technology (i.e., communicating with the access node itself). This may include causing the wireless device 500 to deactivate one or more antenna components of the first wireless communication circuitry 531 and activate one or more antenna components of the second wireless communication circuitry 532.

After an initial switching has been performed, for example to switch the wireless device from the first communication technology to the second communication technology, the monitoring module 512, the logic module 513, and the switching module 514 may be configured to continue performing similar operations relative to the new (second) communication technology. For example, if it is determined that the wireless device is communicating over the second communication technology, the monitoring module 512 may continue to monitor the communication parameter (e.g., by intermittently pinging the local router using the first communication technology). The monitoring module 512 may also be configured to continue monitoring the resource availability for the access node to which the wireless device 500 is now connected. Subsequently, in response to a further determination made by the logic module 513 (e.g., a determination that the communication parameter now exceeds the communication threshold, a determination that the resource availability is now low, or both), the switching module 514 may be configured to cause the wireless device 500 to switch from communication with the access node over the second communication technology back to communication with the local router over the first communication technology. This may include causing the wireless device 500 to activate one or more antenna components of the first wireless communication circuitry 531 and deactivate one or more antenna components of the second wireless communication circuitry 532. In some implementations, the switching module 514 may be configured to wait for a predetermined amount of time after causing the first switching operation before causing any subsequent switching, for example in order to prevent switching from occurring at an undesirably high frequency.

While the above descriptions provides on example in which the setting module 511, the monitoring module 512, the logic module 513, and the switching module 514 are included in the wireless device 500, in other implementations one or more of the modules may be included in the access node 300 and/or the local router 400. In such implementations, the access node 300 and/or the local router 400 may transmit an instruction to the wireless device 500 to initiate the switching operation.

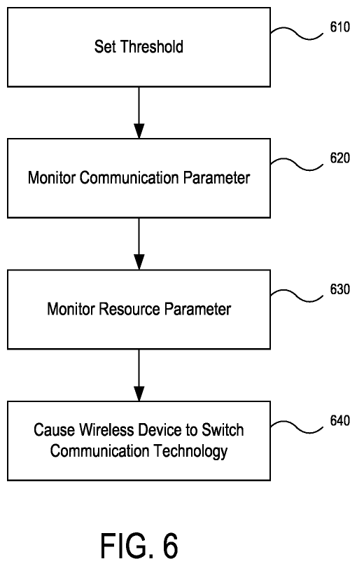

FIG. 6 illustrates an exemplary process flow for managing resources (i.e., for dynamically a wireless device from one communication technology to another). The operations of FIGS. 6 will be described as being performed by the wireless device 500 (e.g., by the processor thereof) in communication with the access node 300 and/or the local router 400 for purposes of explanation. In other implementations, the operations may be performed by or under the control of a processing node external to the wireless device 500, and may be performed with regard to communications with a device other than the access node 300 and/or the local router 400. Generally, the process flow of FIG. 6 may be implemented using any wireless device that is configured to communicate with a network via multiple different technologies.

The process flow begins at operation 610 with setting or determining a communication threshold. The communication threshold may be a threshold signal level below which it may be determined that the communications using the RAT corresponding to the signal are undesirably poor. In one example, the communication threshold may correspond to communications in the first communication technology. The communication threshold may be set by a network operator. In some implementations, the communication threshold may be set in advance and stored in memory, such that “determining” the threshold includes retrieving the threshold from memory. In examples, multiple communication thresholds may be set or determined.

At operation 620, the process flow monitors one or more communication parameters. The communication parameter may correspond to a signal strength for communications between the wireless device 500 and a local router (e.g., the local router 400). The communication parameter may be related to any measure of the quality or strength of wireless communications between the wireless device 500 and the local router using the first communication technology, including but not limited to a throughput, a signal level, an RF signal strength, a SNR, a SINR, a RNR, a latency, a packet loss percentage, and the like. The value of the communication parameter may be determined as an average over a predetermined time window, the length of which may be set or reset by a network operator. In some implementations, the actual value of the communication parameter may be determined by the local router itself, operation 620 may includes monitoring information from the local router in determining the actual value of the communication parameter. The procedures performed in operation 620 may be performed continuously or continually, such as at predetermined time intervals the length of which may be determined by a network operator.

At operation 630 the process flow performs monitoring or determining the resource status of the network, such as by querying and/or receiving the resource status or information related thereto from the network (e.g., from the local router or from an access node). The resource status may correspond to an amount of available resources for communications using the second communication technology between the wireless device 500 and the access node 300 using the second communication technology, including but not limited to an amount of used or available RBs or RBGs. The procedures performed in operation 630 may be performed continuously or continually, such as at predetermined time intervals the length of which may be determined by a network operator. In determining the resource status, operation 630 may include the use or receipt of historical data over a predetermined period of time (e.g., a period set by the network operator), which in some implementations is stored in a memory. In some implementations, the resource status may be determined by an ML or AI algorithm, for example based on a historical resource usage of an access node, and may be queried by the wireless device 500. In such implementations, the ML or AI algorithm may reside in the access node, in the wireless device 500, or in any other network entity. The ML or AI algorithm may be trained on one or more datasets including historical resource usage, traffic, latency, or other parameters related to a resource allocation of the network.

Operations 620 and/or 630 may include various logic operations, including but not limited to operations of comparing, monitoring, and identifying various aspects of the network and/or the wireless device 500. The logic operations may determine whether the wireless device 500 is at or near an edge of a coverage area of the local router (e.g., at a periphery of the first coverage area 234 shown in FIG. 2). In an example of determining that the wireless device 500 is near the edge, operation 620 may include the communication parameter with the communication threshold. Operation 620 may furthering include outputting the result of the determination; for example, outputting a signal indicating whether the communication parameter is above or below the communication threshold. In other implementations, said output may be performed as part of operation 630 and based on the resource status; for example, by only outputting the signal indicating whether the communication parameter is above or below the communication threshold if the resource status indicates a certain amount of available resources for communication using the second communication technology. Operation 630 may additionally or alternatively include determining whether an expected communication quality (e.g., expected signal strength, expected throughput, expected latency, etc.) between the network and the wireless device is higher using the first communication technology or using the second communication technology.

In response to a determination that the communication parameter is below the communication threshold and based on the resource status, at operation 640 the process flow causes the wireless device 500 to switch from communicating with the network indirectly using the first communication technology (i.e., communicating with the local router which in turn communicates with the access node) to communicating with the network directly using the second communication technology (i.e., communicating with the access node itself). This may include causing the wireless device 500 to deactivate one or more antenna components of the first wireless communication circuitry 531 and activate one or more antenna components of the second wireless communication circuitry 532.

After an initial switching has been performed, for example to switch the wireless device 500 from the first communication technology to the second communication technology, some or all of operations 610-640 may be continuously or continually repeated, performing similar operations relative to the new (second) communication technology. For example, if it is determined that the wireless device is communicating over the second communication technology, the process flow may return to operation 620 to monitor the communication parameter (e.g., by intermittently pinging the local router using the first communication technology). Operation 630 may also be performed with regard to the second communication techonology to continue monitoring the resource availability for the access node to which the wireless device 500 is now connected. Subsequently, in response to a further determination made in operations 620 and/or 630 (e.g., a determination that the communication parameter now exceeds the communication threshold, a determination that the resource availability is now low, or both), operation 640 may be repeated cause the wireless device 500 to switch from communication with the access node 300 over the second communication technology back to communication with the local router over the first communication technology. This may include causing the wireless device 500 to activate one or more antenna components of the first wireless communication circuitry 531 and deactivate one or more antenna components of the second wireless communication circuitry 532. In some implementations, operation 640 may include waiting for a predetermined amount of time after causing the first switching operation before causing any subsequent switching, for example in order to prevent switching from occurring at an undesirably high frequency.

The operations of FIG. 6 need not necessarily be performed one after another in immediate sequence. For example, operation 610 may be performed in advance, for example during a network configuration operation and/or during startup of the access node 300, the local router 400, and/or the wireless device 500. Subsequently, operation 620 and/or 630 may be performed continuously or continually until operation 630 determines that the communication parameter is below the communication threshold and that the resource status permits a switch, at which point operation 640 may occur. Subsequently, operation 620 and/or 630 may again be performed continuously or continually until it is determined that another switching operation should occur, and so on. In some implementations, the process flow of FIG. 6 may implement a waiting period between instances of operation 640 such that switching does not occur at an undesirably high frequency.

The exemplary systems and methods described herein may be performed under the control of a processing system executing computer-readable codes embodied on a computer-readable recording medium or communication signals transmitted through a transitory medium. The computer-readable recording medium may be any data storage device that can store data readable by a processing system, and may include both volatile and nonvolatile media, removable and non-removable media, and media readable by a database, a computer, and various other network devices.

Examples of the computer-readable recording medium include, but are not limited to, read-only memory (ROM), random-access memory (RAM), erasable electrically programmable ROM (EEPROM), flash memory or other memory technology, holographic media or other optical disc storage, magnetic storage including magnetic tape and magnetic disk, and solid state storage devices. The computer-readable recording medium may also be distributed over network-coupled computer systems so that the computer-readable code is stored and executed in a distributed fashion. The communication signals transmitted through a transitory medium may include, for example, modulated signals transmitted through wired or wireless transmission paths.

The above description and associated figures teach the best mode of the invention, and are intended to be illustrative and not restrictive. Many embodiments and applications other than the examples provided would be apparent to those skilled in the art upon reading the above description. The scope should be determined, not with reference to the above description, but instead with reference to the appended claims, along with the full scope of equivalents to which such claims are entitled. It is anticipated and intended that future developments will occur in the technologies discussed herein, and that the disclosed systems and methods will be incorporated into future embodiments. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary is made herein. In particular, the use of the singular articles such as “a,” “the,” “said,” etc. should be read to recite one or more of the indicated elements unless a claim recites an explicit limitation to the contrary.

The Abstract is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

What is claimed is:

1. A method of managing network resources, comprising:
setting a communication threshold;
monitoring a communication parameter for a wireless device connected to a network, wherein the wireless device is configured for communicating with the network using a first communication technology and for communicating with the network using a second communication technology;
receiving a resource status from the network; and
in response to a determination that the communication parameter is below the communication threshold and based on the resource status, causing the wireless device to switch from communicating with the network using the first communication technology to communicating with the network using the second communication technology.

2. The method according to claim 1, wherein the communication parameter corresponds to a signal strength for communications using the first communication technology between the wireless device and a local router.

3. The method according to claim 1, wherein the resource status corresponds to an amount of available resources for communications using the second communication technology between the wireless device and an access node.

4. The method according to claim 1, wherein the second communication technology is a Third Generation Partnership Project (3GPP) radio access technology (RAT) and the first communication technology includes a local connection.

5. The method according to claim 1, wherein receiving the resource status from the network includes querying a machine learning (ML) or artificial intelligence (AI) algorithm.

6. The method according to claim 5, wherein the ML or AI algorithm is configured to determine the resource status based on a historical resource usage of an access node for communications using the second communication technology.

7. A system for managing network resources, comprising:
a local router;
an access node; and
a wireless device capable of communicating with a network via the local router using a first communication technology and via the access node using a second communication technology, the wireless device including at least one electronic processor configured to perform operations including:
monitoring a communication parameter for communications between the wireless device and the local router using the first communication technology, monitoring a resource availability for the access node, and based on the communication parameter and the resource availability, switching from communicating with the network via the local router using the first communication technology to communicating with the network via the access node using the second communication technology.

8. The system according to claim 7, wherein the communication parameter corresponds to a radio frequency (RF) signal strength for transmissions from the local router to the wireless device.

9. The system according to claim 7, wherein monitoring the resource availability includes receiving, from the access node, information regarding a radio resource usage of the access node.

10. The system according to claim 7, wherein the at least one electronic processor is further configured to perform operations comprising determining whether an expected communication quality between the network and the wireless device is higher using the first communication technology or using the second communication technology.

11. The system according to claim 7, wherein the second communication technology is a Third Generation Partnership Project (3GPP) radio access technology (RAT) and the first communication technology includes a local connection.

12. The system according to claim 11, wherein the second communication technology is an Enhanced Mobile Broadband (eMBB) RAT and the first communication technology is a Fixed Wireless Access (FWA) RAT.

13. The system according to claim 7, wherein monitoring the resource availability includes querying a machine learning (ML) algorithm.

14. A wireless device, comprising:
first communication circuitry configured to communicate with an access node indirectly via a local router using a first communication technology;
second communication circuitry configured to communicate with the access node directly using a second communication technology; and
at least one electronic processor configured to, in response to a determination that the wireless device is near an edge of a coverage area of the local router and a determination that an amount of available resources of the access node exceeds a threshold, cause the wireless device to switch from communicating with the access node indirectly using the first communication circuitry to communicating with the access node directly using the second communication technology.

15. The wireless device according to claim 14, wherein first communication circuitry is configured to communicate with the local router using a Wi-Fi radio access technology (RAT), and wherein the local router is configured to communicate with the access node using a Fixed Wireless Access (FWA) RAT.

16. The wireless device according to claim 14, wherein the at least one electronic processor is configured to determine whether the wireless device is near the edge of the coverage area of the local router based on at least one radio frequency (RF) condition for communications between the wireless device and the local router.

17. The wireless device according to claim 14, wherein the at least one electronic processor is configured to determine whether the wireless device is near the edge of the coverage area of the local router at predetermined time intervals.

18. The wireless device according to claim 14, wherein the at least one electronic processor is configured to determine whether the amount of available resources of the access node exceeds a threshold by querying the access node.

19. The wireless device according to claim 14, wherein the at least one electronic processor is configured to determine whether the amount of available resources of the access node exceeds a threshold by invoking an artificial intelligence (AI) or machine learning (ML) algorithm.

20. The wireless device according to claim 14, wherein the threshold is set by a network operator.
